(19) United States
(12) Patent Application Publication
(10) Pub. No.: US 2026/0176192 A1
(43) Pub. Date: Jun. 25, 2026

(54) DECOATING METHODS

(71) Applicant: AGC GLASS EUROPE, Louvain-la-Neuve (BE)

(72) Inventors: Eric MORGANTE, Gosselies (BE); Mohsen YOUSEFBEIKI, Gosselies (BE)

(73) Assignee: AGC GLASS EUROPE, Louvain-la-Neuve (BE)

(21) Appl. No.: 19/129,073

(22) PCT Filed: Dec. 1, 2023
(86) PCT No.: PCT/EP2023/083988

§ 371 Date: May 12, 2025

(30) Foreign Application Priority Data
Dec. 14, 2022 (EP) 22213529

(51) Int. Cl. C03C 17/36; B23K 26/40

(52) U.S. Cl. CPC C03C 17/3626; B23K 26/40; C03C 17/3644; C03C 17/366; C03C 17/3681

(57) ABSTRACT

A method for decoating a glazing unit made of a glass panel with a glass sheet which is low in reflectance for RE radiation, where the glass panel has a bent portion with an axis of curvature. The glazing unit also includes a coating system which is high in reflectance for RF radiation disposed on the glass sheet over part of the bent portion. The decoating method includes: decoating a frequency selective surface on the coating system by decoating a matrix of decoated grids; each of the decoated grids has decoated regions in the form of grid lines arranged in a mesh-like manner; each of the decoated grids has a rectangular generic shape; and the decoating is performed by using a laser apparatus. Each of the decoated grids is inscribed in a specific rectangle paralleled to the axis of curvature, and each is oriented by an angle αmn.

### TECHNICAL FIELD

The present invention relates to a glazing unit comprising a glass panel comprising a glass sheet which is low in reflectance for RF radiation and a coating system which is high in reflectance for RF radiation disposed on the said glass sheet, in general and, more specifically, to an enhanced glazing unit comprising at least a frequency selective surface on the coating system over at least a part of a bent portion of the glazing panel and the method to decoat such glazing unit.

Thus, the invention concerns multiple domains where a glazing unit is used such a mounted on a stationary object, for instance a building, or mounted on a mobile object, for instance a vehicle, a train.

### BACKGROUND ART

In recent years, it is a common practice to reduce electric-power consumption, for example, by moderately using air conditioners or the like for cooling, in order to prevent the global warming. An attempt is being made accordingly to impart the function of a coating system, such as reflecting infrared rays (heat rays), to the glazing unit of vehicles, buildings, etc. to thereby reduce the intake of heat from sunlight to the inside of the vehicles or buildings.

Such coating systems, however, are typically electrically conductive and are high in reflectance for RF radiation. This makes the coating systems efficient reflectors of broad bands of radio frequency signals. Furthermore, commercial construction, automotive, train, . . . tend to use other materials that further block RF signals. Materials such as concrete, brick, mortar, steel, aluminium, roofing tar, gypsum wall board, and some types of wood all offer varying degrees of RF absorption. The result is that many newer constructions severely impede RF signals from getting into or out of the buildings. This effect impedes reception or transmission by antennas and/or terminals.

As a method of providing the window or the like with a heat ray reflection function, for example, a method of forming a thin film containing a metal having a heat ray reflection function such as silver (heat ray reflection film) on a glass sheet or the like can be cited.

When a substrate having a heat ray reflection function is applied to, for example, a window glass, high transparency to radio waves of a predetermined frequency is also required but a coating system is high in reflectance for RF radiation.

Nonetheless, RF devices have become an important part of modern life, especially with the huge penetration of cellular smartphones, tablets, IoT (Internet of Things) devices, that are requiring a deep penetration in the buildings or automotive of electromagnetic field for indoor coverage, even at high spectrum frequencies up to 110 GHz. Such devices may include cellular transceivers, wireless local area network (“Wi-Fi”) transceivers, Global Positioning System (GPS) receivers, Bluetooth transceivers and, in some cases, other RF receivers (e.g., FM/AM radio, UHF, etc.). As the popularity of such devices has grown, the importance of being able to use RF-based features within the confines of modern commercial buildings has grown.

In addition, in order to increase the speed and capacity of wireless communication, frequency bands to be used are becoming higher, like the frequency bands for the 5th generation mobile communication system (5G). Therefore, even if a high-frequency electromagnetic wave having a broadband frequency band is used for a mobile communication, etc., it is necessary to have a wide band frequency selective surface in order to ensure the transmission of waves with different frequencies through the glazing unit.

The ITU IMT-2020 specification demands speeds up to 20 Gbps, achievable with wide channel bandwidths and massive MIMO 3rd Generation Partnership Project (3GPP) is going to submit 5G NR (New Radio) as its 5G communication standard proposal. 5G NR can include lower frequencies, below 6 GHz, and mmWave, above 15 GHz. However, the speeds and latency in early deployments, using 5G NR software on 4G hardware (non-standalone), are only slightly better than new 4G systems, estimated at 15% to 50% better. On top of that, IoT will requires indoor coverage as better as possible not for massive MTC (Machine Type Communication) but for critical MTC where robots or industrial devices are 5G wireless remotely controlled.

For example, as a method of transmitting radio waves in a frequency band of several hundred MHz to several tens of GHz or more as used in a fourth generation mobile communication system (4 G) or a fifth generation mobile communication system (5 G) in recent years, there is a method of partially removing a heat ray reflection film for coating a substrate by a method such as laser etching.

Among them, as a method of suitably transmitting a radio wave having a predetermined frequency or the like while maintaining the coating system function, it is known to remove the coating system so as to form a periodic pattern in which a portion in which the heat ray reflection film does not exist is composed of a plurality of lines, for example, so as to form a parallel line shape or a lattice shape forming a FSS in the form of grid lines arranged in a mesh-like manner.

In the case of removing the heat ray reflecting film by laser etching, generally, there is a limit on the size of a region that can be laser-processed in one process. For example, US-A-2013/0295300 describes a method in which a relatively wide region can be laser-processed relatively quickly in one process, but the size of the region that can be laser-processed in one process may still be insufficient for the size of the entire region to be processed. Therefore, when laser processing is performed on a region larger than a region that can be processed in one process, a pattern formed in a predetermined size that can be processed in one process is formed a plurality of times and continuously arranged. As a result, a continuous pattern can be formed in the entire desired region by connecting decoated tile-like portions like a so-called patchwork.

At this time, in order not to impair the radio wave transparency or the aesthetic appearance, it is ideal that a discontinuity or a deviation of a pattern does not occur at a joint between a plurality of patterns formed in mutually different processes. However, it is difficult to completely control the pattern forming position, and it is necessary to take into consideration that some error occurs in the pattern forming position at the time of laser processing. In particular, since the radio wave transparency is liable to be impaired when the pattern is interrupted, it is required to connect the patterns as reliably as possible in order to suppress this.

On the other hand, in the case of forming a lattice pattern, for example, by arranging a plurality of lattice patterns formed in mutually different processes so as to partially overlap each other, it is possible to suppress the interruption of the pattern that impairs the radio wave transparency.

According to the prior art, as soon as the glass is curved, it is even impossible to decoat it. Thus, FSS are only created on the flat parts of the glazing panels.

An object of one embodiment of the present invention is to provide a glazing unit capable of increasing the transmission of waves with a specific frequency such as with lower frequencies, below 6 GHz, and/or mmWave, above 15 GHz through the glazing unit while making the connection between adjacent tiles almost invisible to the eye while the FSS is performed at least on a bent part of the glazing panel.

### SUMMARY OF INVENTION

The present invention relates, in a first aspect, to a decoating method for decoating a glazing unit comprising a glass panel comprising a glass sheet which is low in reflectance for RF radiation, the glass panel comprising a bent portion with an axis of curvature Acmn. The glazing unit further comprises a coating system which is high in reflectance for RF radiation disposed on the said glass sheet over at least a part of the bent portion.

The solution as defined in the first aspect of the present invention is based on that the decoating method comprises a step of decoating a frequency selective surface on the coating system by decoating a matrix of decoated grids, Gmn, connected together two-by-two and edge-to-edge; each of the plurality of decoated grids has decoated regions in the form of grid lines arranged in a mesh-like manner; each of the plurality of decoated grids has a rectangular generic shape with a length Lmn and a width Wmn, where m and n represent the two indices of each decoated grid of the matrix; the decoating step is performed by using a laser apparatus having a scan field, Lmax, and a zone Rayleigh, Za.

The solution as defined in the first aspect of the present invention is also based on that each of the plurality of decoated grids is inscribed in a specific rectangle having a length LRmn and a width WRmn which is paralleled to the axis of curvature Acmn. Each of the plurality of decoated grids is oriented by an angle αmn to the corresponding specific rectangle. Said length and said width are measured along the surface of the coating system

The solution as defined in the first aspect of the present invention is also based on that the width Wmn:

$$Wmn = \frac{WRmn * cos α mn - LRmn * sin α mn}{( {cos}^{2} α mn - {sin}^{2} α mn )}$$

and the length Lmn

$$Lmn = \frac{LRmn - Wmn * sin α mn}{cos α mn}$$

wherein
WRmn is comprised between 50% up to 100% of the minimum between Lmax and Wr wherein Wr=2*sqrt(2*Za*Rmn−Za²);
LRmn is comprised between 50% up to 100% of Lmax;
Rmn corresponds to the radius of the glass sheet at the corresponding specific rectangle of a decoated grid Gmn measured in the axis of the length
αmn≠kπ/2 wherein k is an odd number (k=1, 3, 5, . . . ).

The invention permits to decoat a frequency selective surface, made of decoated grids over a bent part of a glazing panel while keeping connected decoated grids.

The present invention relates, in a second aspect, to a partially decoated glazing unit treated by the decoating method according to the first aspect of the present invention.

The present invention relates, in a third aspect, to a decoating apparatus to obtain a partially decoated glazing unit according to the second aspect of the invention using the method according to first aspect of the invention.

It is noted that the invention relates to all possible combinations of features recited in the claims or in the described embodiments.

The following description relates to transportation fields such as train but it's understood that the invention may be applicable to others fields like building applications or other transportation applications like car, buses, or any other fields where a glazing panel comprising a bent portion can be decoated to obtain a frequency selective surface over this bent portion.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic view of the decoating step according to the first aspect of the invention.

FIG. 2 is a schematic view of the decoated method according to some embodiments according to the invention.

FIG. 3 is a schematic view of the decoated method according to some other embodiments according to the invention.

FIG. 4 is a schematic 3D view of a partially decoated glazing unit according to the invention.

FIG. 5 is a sectional view along axis AA′ of the coating system disposed on the glazing unit illustrated in FIG. 4.

FIG. 6 is a schematic view of a decoated grid inscribed in its specific rectangle.

FIG. 7 is a schematic view of a frequency selective surface comprising a matrix of decoated grids Gmn.

FIG. 8 is a schematic view of a connection between two decoated grids of the matrix connected together according to some embodiments.

FIG. 9 is a schematic view of a connection between two decoated grids of the matrix connected together according to some embodiments.

FIG. 10 is a schematic view of a connection between two decoated grids of the matrix connected together according to some embodiments.

### DETAILED DESCRIPTION

In this document to a specific embodiment and include various changes, equivalents, and/or replacements of a corresponding embodiment. The same reference numbers are used throughout the drawings to refer to the same or like parts.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

It is an object of the present invention to alleviate the above described problems an efficient and discrete frequency selective surface on the coating system.

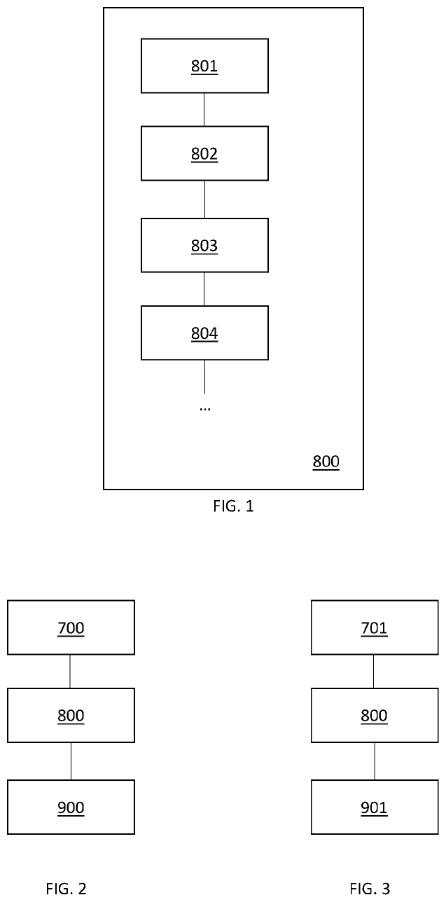

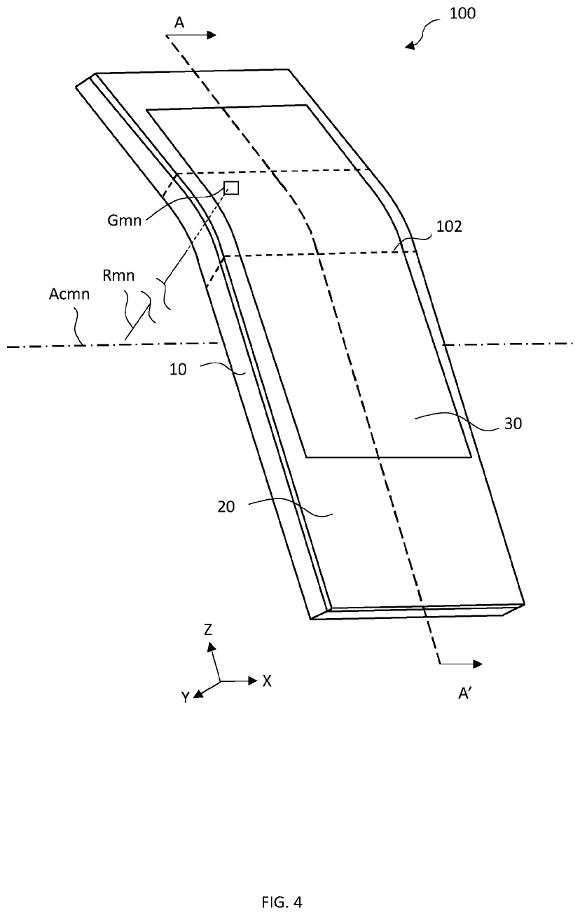

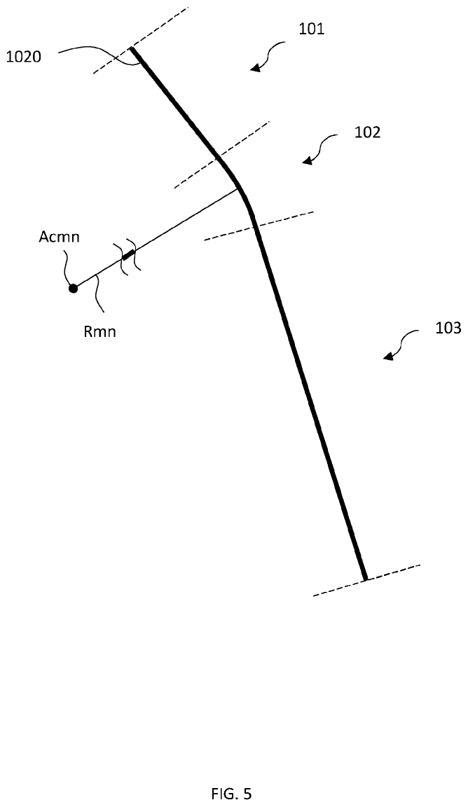

Especially, as illustrated in FIG. 1, the object of the first aspect of the present invention is a decoating method 800 for decoating a glazing unit to obtain a partially decoated glazing unit 100, as illustrated in FIG. 4.

### <Glazing Unit>

A glazing unit 100, according to the invention, can be used as a window, especially to close an opening of the stationary object, such as a building, or to close an opening of the mobile object, such a train, a boat, a car, . . . .

In FIG. 4, the glazing unit has a height measured along the Z-axis, a width measured along the X-axis and a thickness measured along the Y-axis. The shape of the glazing panel in a plane view (X-Z plane) is not limited to a rectangle, and may be a circle or the like. In the present embodiment, the rectangle includes not only a rectangle or a square but also a shape obtained by chamfering corners of a rectangle or a square. The dimensions and/or the shape of the glazing unit depends on the desired application.

### <Glass Sheet>

According to the invention, the glazing unit 100 comprises a glazing panel comprising a glass sheet 1 which is low in reflectance for RF radiation.

Low in reflectance for RF radiation means that RF radiation are mostly transmitted through the material where high in reflectance for RF radiation means that RF radiation are mostly reflected on the surface of the material and/or absorbed by the material and the attenuation is at level of 20 decibels (dB) or more. Low in reflectance means an attenuation at level of 10 decibels (dB) or less.

The shape of the glazing panel in a plane view (X-Z plane) is not limited to a rectangle, and may be a circle or the like. In the present embodiment, the rectangle includes not only a rectangle or a square but also a shape obtained by chamfering corners of a rectangle or a square.

In some embodiments, the glass panel is at least transparent for visible waves in order to see-through and to let visible light passing through, meaning that the light transmission is greater than or equal to 1%.

In some embodiments, the glazing panel comprises at least two s separated by a spacer allowing to create a space filled by a gas like Argon to improve the thermal isolation of the glazing unit, creating an insulating glazing unit.

In some embodiments, the glazing panel comprises at least two glass sheets separated by spacers allowing to create a vacuum space to improve the thermal isolation of the glazing unit, creating a vacuum insulating glazing (VIG).

In some embodiments, the glazing panel can be a laminated glazing panel to reduce the noise and/or to ensure the penetration safety. The laminated glazing comprises glazing panels maintained by one or more interlayers positioned between glazing panels. The interlayers employed are typically polyvinyl butyral (PVB) or ethylene-vinyl acetate (EVA) for which the stiffness can be tuned. These interlayers keep the glazing panels bonded together even when broken in such a way that they prevent the glass from breaking up into large sharp pieces.

In some embodiments, the glazing panel can be an insulated and laminated glazing panel.

As the material of the glazing panel, for example, soda-lime silica glass, borosilicate glass, or aluminosilicate glass can be mentioned or other materials such as thermoplastic polymers, polycarbonates are known, especially for automotive applications, and references to glass throughout this application should not be regarded as limiting.

The glazing panel can be manufactured by a known manufacturing method such as a float method, a fusion method, a redraw method, a press molding method, or a pulling method. As a manufacturing method of the glazing panel, from the viewpoint of productivity and cost, it is preferable to use the float method.

The glass sheet can be processed, i.e. annealed, tempered, . . . to respect with the specifications of security and anti-thief requirements.

The glass sheet can be a clear glass or a colored glass, tinted with a specific composition of the glass or by applying an additional coating or a plastic layer for example.

In embodiments where the glass panel comprises several glass sheets each glass sheet can be independently processed and/or colored, . . . in order to improve the aesthetic, thermal insulation performances, safety, . . . .

The thickness of the glazing panel is set according to requirements of applications.

The glazing panel can be formed in a rectangular shape in a plan view by using a known cutting method. As a method of cutting the glazing panel, for example, a method in which laser light is irradiated on the surface of the glazing panel to cut the irradiated region of the laser light on the surface of the glazing panel to cut the glazing panel, or a method in which a cutter wheel is mechanically cutting can be used. The glazing panel can have any shape in order to fit with the application, for example a windshield, a sidelite, a sunroof of an automotive, a lateral glazing of a train, a window of a building, . . . .

In addition, the glazing unit can be assembled within a frame or be mounted in a double skin façade, in a carbody or any other means able to maintain a glazing unit. Some plastics elements can be fixed on the glazing panel to ensure the tightness to gas and/or liquid, to ensure the fixation of the glazing panel or to add external element to the glazing panel.

According to the invention, the glass panel comprising a bent portion 102. The bent portion is a cylindrical bent portion meaning that the glass panel is bent along a single axis.

In some embodiments, the glazing unit can further have a flat portion extending from a part of the bent portion.

The glass panel can be bent by known methods such as hot or cold bending.

The glazing unit 100, illustrated in FIG. 4, has a first flat portion 101, a bent portion 0102 and a second flat portion 103. Such glazing unit are typically used in double deck train.

In such embodiments, the bent portion is a cylindrical bent portion having a axis of curvature Acmn along the axis X. The curvature can differ on each line of the matrix of decoated grids.

According to the invention, the bent portion has a radius of curvature Rmn. This radius can be the same or can differ from a point to another along the surface of the glass sheet.

It is understood that the radius is measured at the surface of the glass sheet where the coating system is disposed on.

### <Coating System>

According to the invention, the glazing unit 100 comprises a coating system 20 which is high in reflectance for RF radiation. Said coating system 20 is disposed on the said glass sheet 10 over at least a part of the bent portion (102).

The coating system is high in reflectance meaning that the coating system is low in transmittance for RF radiation. Low in transmittance means a transmission with an attenuation at level of 20 decibels (dB) or more. It is understood that the dielectric substrate is low in reflectance, meaning an attenuation at level of 10 decibels (dB) or less.

According to the invention, the coating system 20 can be a functional coating in order to heat the surface of the glass sheet, to reduce the accumulation of heat in the interior of a building or vehicle or to keep the heat inside during cold periods for example. Although coating system are thin and mainly transparent to eyes in order to see-through and to let visible light passing through.

The coating system 20 can be made of layers of different materials and at least one of this layer is electrically conductive. The coating system is electrically conductive over the majority of one major surface of the glass sheet, in the X-Z plane.

The coating system 20 of the present invention has an emissivity of not more than 0.4, preferably less than 0.2, in particular less than 0.1, less than 0.05 or even less than 0.04. The coating system of the present invention may comprise a metal based low emissive coating system; these coatings typically are a system of thin layers comprising one or more, for example two, three or four, functional layers based on an infrared radiation reflecting material and at least two dielectric coatings, wherein each functional layer is surrounded by dielectric coatings. The coating system of the present invention may in particular have an emissivity of at least 0.010. The functional layers are generally layers of silver with a thickness of some nanometres, mostly about 5 to 20 nm. Concerning the dielectric layers, they are transparent and traditionally each dielectric layer is made from one or more layers of metal oxides and/or nitrides. These different layers are deposited, for example, by means of vacuum deposition techniques such as magnetic field-assisted cathodic sputtering, more commonly referred to as “magnetron sputtering”, or Chemical deposition such as CVD or PECVD or any other known deposition method. In addition to the dielectric layers, each functional layer may be protected by barrier layers or improved by deposition on a wetting layer.

In some embodiments, the coating system 20 is applied to the glass sheet to transform it to a low-E glazing unit. This metal-based coating system such as low-E or heatable coating systems.

In some embodiments, the coating system 2 can be a heatable coating applied on the dielectric substate, especially a glazing panel, to add a defrosting and/or a demisting function for example.

As the coating system, for example, a conductive film can be used. As the conductive film, for example, a laminated film obtained by sequentially laminating a transparent dielectric, a metal film, and a transparent dielectric, ITO, fluorine-added tin oxide (FTO), or the like can be used. As the metal film, for example, a film containing as a main component at least one selected from the group consisting of Ag, Au, Cu, and Al can be used.

Preferably, the coating system is placed on the majority of one surface of the glazing unit and more preferably on the whole usable surface of the glazing panel, in the X-Z plane.

In some embodiments, a masking element, such as an enamel layer, can be add on a part of the periphery of the glazing unit to hide the transition between a coated area and an non-coated area.

In some embodiments, the glazing unit can comprises several coating systems applied on same or different surface(s) of a glass sheet.

In some embodiments where the glazing panel comprises several glass sheets, different or same coating systems can be placed on different surfaces of the glass sheets.

### <Frequency Selective Surface>

According to the invention, the glazing unit comprises at least one frequency selective surface 30 on the coating system 20 decoated by a step of decoating 800. This at least one frequency selective surface comprises a matrix of decoated grids, Gmn, connected together two-by-two and edge-to-edge. Each of the plurality of decoated grids has decoated regions in the form of grid lines arranged in a mesh-like manner; each of the plurality of decoated grids has a rectangular generic shape with a length Lmn and a width Wmn.

The at least one frequency selective surface is situated within the coating system, over at least a part of the bent portion, and forms a communication window to let RF radiations passing thought the coating system and through the glazing unit depending on the grid parameters, such as distance between grid lines and shape of the grid mesh.

In the context of the invention, the term “decoated grid” includes a portion within the coating, which has, for example, linear decoating by a laser. The linear decoating forms a pattern with net meshes.

The linear decoating are visible in some incident angle due to the difference of colour between the decoating and the coating system.

The position and the dimension of the at least one frequency selective surface depend on the application.

### <Decoated Grid>

According to the present invention, the said at least one frequency selective surface 3 comprises a matrix of decoated grids Gmn, where m and n respectively represent the row index and the column index of each decoated grid of the matrix.

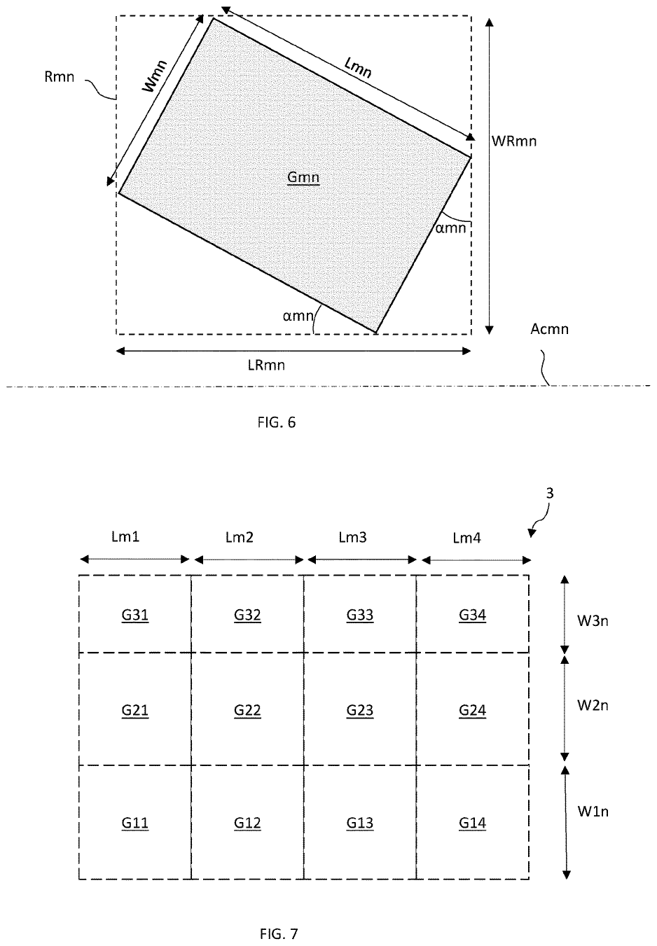

According to the invention, as illustrated in FIG. 6, each of the plurality of decoated grids is inscribed in a specific rectangle Rmn having a length LRmn and a width WRmn which is paralleled to the axis of curvature Acmn. Each of the plurality of decoated grids is oriented by an angle αmn to the corresponding specific rectangle.

The width of each of decoated grids of the matrix equals to

$$Wmn = \frac{WRmn * cos α mn - LRmn * sin α mn}{( {cos}^{2} α mn - {sin}^{2} α mn )}$$

and the length of each of decoated grids of the matrix equals to

$$Lmn = \frac{LRmn - Wmn * sin α mn}{cos α mn}$$

wherein:
WRmn is comprised between 50% up to 100% of the minimum between Lmax and Wr wherein Wr=2*sqrt(2*Za*Rmn−Za²);
LRmn is comprised between 50% up to 100% of Lmax;
Rmn corresponds to the radius of the glass sheet at the corresponding specific rectangle of a decoated grid Gmn measured in the axis of the length
αmn≠kπ/2 wherein k is an odd number.

Preferably, to optimize the decoating time while maximizing the surface, WRmn is comprised between 80% up to 100% of the minimum between Lmax and Wr wherein Wr=2*sqrt(2*Za*Rmn−Za²), preferably Lmn is comprised between 90% up to 100% of the minimum between Lmax and Lr.

In some preferred embodiment, each of the αmn are equals to the same angle α11 to have a rectangular matrix while edges of adjacent tiles are similar.

According to one embodiment, the decoated grid has a generic shape with an edge of about 90 mm with a rectangular net of 4×4 mm meaning that the matrix comprises between 20 and 25 decoated grid per row or column meaning that m is between 1 and 25 and n is between 1 and 25.

In a simple embodiment, the matrix is a 3×4, then the matrix is composed of 12 decoated grids, G11, G12, G13, G14, G21, G22, G23, G24, G31, G32, G33, G34.

Preferably, at the connection between two adjacent connected decoated grids, the length of the edges of two connected decoated grid is equal, the length L81 of the decoated grid G8 equals the length L94 of the decoated grid G9.

Coming back to FIG. 1, the step of decoating 800 is performed by using a laser apparatus having a scan field, Lmax, and a zone Rayleigh, Za and comprises several sub-steps 801, 802, 803, 804, . . . . Each of the several sub-steps corresponds to a decoating sub-step of one of the decoated grids.

According to the invention, the laser apparatus emits a laser beam which is focused on the coating system to correctly decoat the desired portion. Preferably, the laser apparatus comprises a galvo head designed to orientate the laser beam to create the desired design of the mesh-like inside the decoated grid in an optimized time. Then the laser head and/or the glazing unit moves to have the laser head in front of the next area to decoat.

To avoid to adapt the focus point of the laser beam inside the decoated grid, the laser apparatus comprises a F-theta lens to flatten the focus point on a surface.

Preferably, the laser apparatus is a pulse laser apparatus and the frequency of the laser beam equals to or is higher than substantially 20 kHz.

Each of the decoating sub-step is made by using the laser apparatus that is moved from a position, corresponding to a decoating sub-step to another position, corresponding to the adjacent position and to the next decoating sub-step. To decoat inside a defined surface, the laser apparatus can comprises a slitter system design to slit the laser beam into several laser beams.

According to the invention, to ensure that the coating system is correctly decoated while keeping the connection between adjacent decoated grids, the length, Lmx, of each of the m decoated grids, measured along the surface of the coating system, is comprised between 50% up to 100% of the minimum between Lmax and Lr wherein Lr=2*sqrt(2*Za*Rmx−Za²), Rmx corresponds to the radius of the glass sheet at the corresponding decoated grid Gm measured along the axis of the length Lmx. In some preferred embodiments, Lmx can be comprised between 80% up to 100% of the minimum between Lmax and Lr and more preferably Lmx is comprised between 90% up to 100% of the minimum between Lmax and Lr.

It is understood that depending on the curvature of the glass panel and the orientation of the decoated grids, the edges of a decoated grid can be different.

The radius of curvature is measured at the surface of the glass panel where the coating system is disposed on.

According to the invention, a flat portion has no radius of curvature or an infinite radius of curvature. Thus, for a flat portion or for a large radius of curvature, the length of the decoated grid is limited by Lmax to permit to the laser beam to decoat correctly the desired mesh-like inside the decoated grid.

Preferably, the scan field depends such as the zone Rayleigh of the laser apparatus used for decoating the coating system.

Preferably, the Zone Rayleigh Za can between 0.5 mm to 1.5 mm and more preferably Za is between 0.8 mm and 1.2 mm depending on the specific application.

The scan field can preferably be between 50 mm and 200 mm.

In some embodiments, in which the method of decoating is performed the laser apparatus having a Za of 1.2 mm with a scan field of 90 mm and in which the glass panel has a bent part with radius of curvature of 1500 mm at a decoating grid, the length of the edge of the decoating grid is the min between 90 mm and 109.53 mm then, the laser apparatus will decoat a decoated grid comprised in a zone of 90 mm.

In some embodiments, in which the method of decoating is performed the laser apparatus having a Za of 1.2 mm with a scan field of 90 mm and in which the glass panel has a bent part with radius of curvature of 1000 mm at a decoating grid, the length of the edge of the decoating grid is the min between 90 mm and 89.42 mm then, the laser apparatus will decoat a decoated grid comprised in a zone of 89 mm.

In some embodiments, in which the method of decoating is performed the laser apparatus having a Za of 1.2 mm with a scan field of 90 mm and in which the glass panel has a bent part with radius of curvature of 500 mm at a decoating grid, the length of the edge of the decoating grid is the min between 90 mm and 63.21 mm then, the laser apparatus will decoat a decoated grid comprised in a zone with a edge of 63 mm.

According to the invention it means that the decoated grid is inscribed in an area that in all direction the corresponding diameter dm is smaller than or equals to the minimum between Lmax and Lr wherein Lr=2*sqrt(2*Za*Rm_dm−Za²) where Rm_dm corresponds to the equivalent radius along measured in the axis of the corresponding diameter.

Preferably, the specific rectangle Rmn is a specific square meaning that the LRmn equals to WRmn to simplify the decoating sub-steps and the design of the mesh-like.

Preferably, to minimize the handle and the misalignment, each of the αmn are equals to the same angle α11 that is substantially equal to 0. That means that Wmn equals to WRmn and Lmn equals to LRmn.

In some preferred embodiments, the decoating grids has a generic shape of a square without orientation compared to the axis of curvature, then Wmn=Lmn and comprised between 80% up to 100% of the minimum between Lmax and Wr wherein Wr=2*sqrt(2*Za*Rmn−Za²).

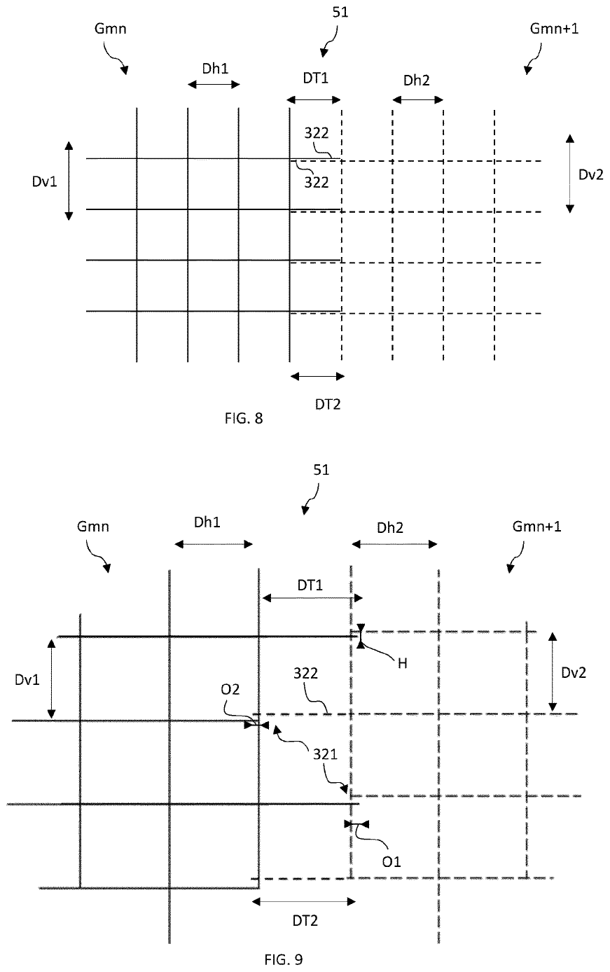

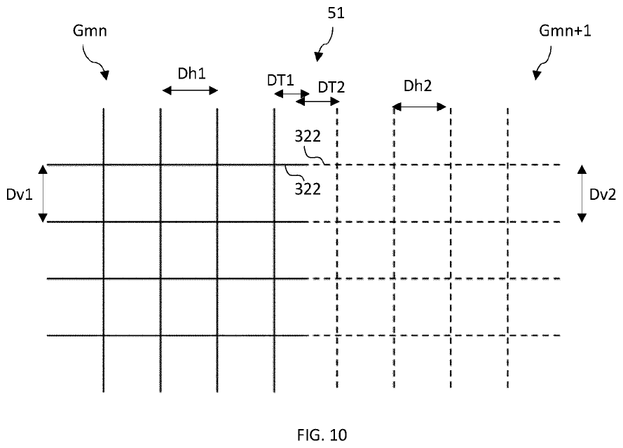

As illustrated in FIG. 8, FIG. 9 and FIG. 10, a decoated grid has decoated regions, in black colour, in the form of grid lines arranged in a mesh-like manner, creating zones, in white colour, where the coating system is still present. This permits to maximize the untouched, meaning the surface in which the coating system has not been removed, surface of the coating system to keep properties of the coating system.

The grid meshes must have a distance between the lines that is significantly smaller than the wavelength of the desired electromagnetic radiation in question. To that end, the metal-containing coatings are, for example, removed in the form of lines using a suitable laser. Since only small amounts of the metal-containing coating have to be removed, the infrared radiation absorbing effect is largely retained.

Preferably, decoated segments can have a width between 10 μm and 150 μm, preferably between 15 μm and 70 μm, and more preferably substantially 30 μm.

According to the invention, the decoated grids are connected together two-by-two and edge-to-edge at a connection area.

According to the invention, the term “connection area” corresponds to the area of connection between two adjacent decoated grids. Preferably, as illustrated in FIG. 8, FIG. 9 and FIG. 10, a connection area 51 corresponds to an edge of a decoated grid, the decoated grid Gmn (i.e G23), connected to the corresponding edge of the adjacent decoated grid, the decoated grid Gmn+1 (i.e. G24). It is understood that the an adjacent decoated grid to Gmn (i.e. G23) can be Gm−1,n (i.e. G13) or Gm+1,n (i.e. G33), Gmn−1 (i.e. G22) or Gmn+1 (i.e. G24).

The term “connected” means that at least one of the decoating lines of a decoated grid touches or overlaps a decoated line of the adjacent decoated grid.

According to the invention, at least at the connection area, decoated grids can comprise a rake design in which on at least one side, the grid lines are not closed by surrounding grid lines and thus form a rake structure with teeth 322. It is understood that the rake design means an open structure oriented towards the exterior of the decoated grid. FIG. 8, FIG. 9 and FIG. 10 illustrate some embodiments in which the decoated grids Gmn has teeth with a length DT1 touching at least a decoated line of a decoated grid Gmn+1 to establish that the decoated grid Gmn is connected to the decoated grid Gmn+1.

In such embodiments, the linear decoating forms a pattern with rectangular net meshes, preferably square net meshes. the decoated grid. The decoated line of a decoated grid Gmn+1 touched or overlapped by the tooth 322 of the decoated grids Gmn can be a any decoated line such as a edge of the net meshes.

Preferably, to ensure the connection between to adjacent decoated grids, the decoated grids Gmn has teeth 322 with a length DT1 touching at least a decoated line of a decoated grid Gmn+1 while the decoated grids Gmn+1 has teeth 322 with a length DT2 touching at least a decoated line of a decoated grid Gmn.

Preferably, a tooth 322 is a continuation of the grid line to optimize (minimizing) time of the decoating step.

In some embodiments, as illustrated in FIG. 8, FIG. 9 and FIG. 10, the decoated grid can comprises a rake design on at least another side than on the connection side.

FIG. 9 illustrates some embodiments where the rake design of the decoated grid has at least a missing tooth 321 meaning that, at least at the connection area, the decoated grid Gmn comprises a rake design with at least a missing tooth 321 and the decoated grid Gmn+1 comprises a rake design with at least a missing tooth 321. A sequence of teeth and missing teeth can vary according to the desired application.

Preferably, to optimize the decoating process and to reduce the time of decoating a decoated grid, the grid lines form squares and/or rectangles.

In some embodiments, the squares are 2×2 mm squares. In some other embodiments squares are 4×4 mm squares. Dimensions of the squares depend of the desired EM frequency to let pass through the glazing unit.

Preferably, to optimize the decoating process and to reduce the time of decoating the frequency selective surface, the decoated grid s that composed the patchwork to create the frequency selective surface have same dimensions and grid lines forms same shape with same dimensions.

In some other embodiments, depending on the specific application, dimensions of each decoated grid or dimensions of the shape formed by the grid lines can be different.

In some preferred embodiments, at the connection area, the connection design of the decoated grid Gmn is matching with the connection design of the decoated grid Gmn+1 forming a closed grid. That means that, at least at the connection area, the rake design of the decoated grid Gmn is arranged to minimize teeth overlap and maximize grid pattern continuity and completion when engraved jointly with the decoated grid Gmn+1 or as illustrated in FIG. 10, the length of the teeth are optimized to overlap slightly the corresponding tooth of the adjacent decoated grid. Overlap between corresponding edges is minimized by ensuring that for corresponding edges, rakes are complementary ie tooth from one rake does not overlap with the corresponding tooth of the other rake design and conversely.

According to some embodiments, as illustrated in FIG. 8, the teeth of the rake design of the decoated grid Gmn touches the decoated grid Gmn+1. The length of the teeth DT1 equals to or is longer than the distance between decoated grids Gmn, Gmn+1 to have a connection along the corresponding tooth while if the adjacent is misaligned the connection is ensure with a edge of the net mesh. The length DT1, DT2 of a tooth is from 100% to 150% of the length respectively Dh1 or Dv1, Dh2 or Dv2, depending the direction of the decoated line 331, 332, 333. Preferably, The length DT1, DT2 of a tooth for the connection is from 100% to 150%, that means the overlap O1, O2 is from 0% to 100. In the term of the invention, a decoated grid connected to another decoated grid means that at least one decoated line 331, 332, 333, preferably a tooth is used for the connected of the decoated grid, interacts with the decoated lines of the other decoated grid.

According to some embodiments, as illustrated in FIG. 9, the teeth of the rake design of the decoated grid Gmn touches the decoated grid Gmn+1. The length of the teeth DT1 equals to or is longer than the distance between decoated grids Gmn, Gmn+1 to have the connection with a edge of the net mesh. The length DT1, DT2 of a tooth is from 100% to 150% of the length respectively Dh1 or Dv1, Dh2 or Dv2, depending the direction of the decoated line 331, 332, 333. Preferably, The length DT1, DT2 of a tooth for the connection is from 100% to 150%. In the term of the invention, a decoated grid connected to another decoated grid means that at least one decoated line 331, 332, 333, preferably a tooth is used for the connected of the decoated grid, interacts with the decoated lines of the other decoated grid.

According to some embodiments, as illustrated in FIG. 10, the teeth of the rake design of the decoated grid Gmn touches the decoated grid Gmn+1. The length of the teeth DT1 equals to or is longer than the half of the distance between decoated grids Gmn, Gmn+1 to have a connection along the corresponding tooth. The length DT1, DT2 of a tooth is from 50% to 150%, preferably from 50% to 80%, of the length respectively Dh1 or Dv1, Dh2 or Dv2, depending the direction of the decoated line 331, 332, 333. That means the overlap O1, O2 is from 0% to 150%. In the term of the invention, a decoated grid connected to another decoated grid means that at least one decoated line 331, 332, 333, preferably a tooth is used for the connected of the decoated grid, interacts with the decoated lines of the other decoated grid.

In some embodiments, the overlap O1 is from 0 mm to 0.4 mm, preferably from 0 mm to 0.2 mm, and more preferably from 0 mm to 0.1 mm.

In some embodiments, the overlap O2 is from 0 mm to 0.4 mm, preferably from 0 mm to 0.2 mm, and more preferably from 0 mm to 0.1 mm.

The overlap O1, O2 can depend of the dimensions of the grid.

In some embodiments, due to the decoating process, adjacent decoated grids can be shift, mainly due to a misalignment and/or shifting of the decoating apparatus during the decoating steps, and a distance H can occur. It is understood that, preferably, the distance H is minimized and near 0 mm.

More preferably, to ensure a good RF transparency, the decoated grid Gmn is connected to the second decoated grid by more than 50% of the teeth of the rake design of the decoated grid Gmn, preferably the decoated grid Gmn is connected to the decoated grid Gmn+1 by more than 80% of the teeth of the rake design of the decoated grid Gmn and more preferably the decoated grid Gmn is connected to the decoated grid Gmn+1 by more than 90% of the teeth of the rake design of the decoated grid Gmn.

More preferably, to ensure a good RF transparency, wherein the decoated grid Gmn is connected to the decoated grid Gmn+1 by more than 50% of the teeth of the rake design of the decoated grid Gmn+1, preferably the decoated grid Gmn is connected to the decoated grid Gm by more than 80% of the teeth of the rake design of the second decoated grid and more preferably the decoated grid Gmn is connected to the decoated grid Gmn+1 by more than 90% of the teeth of the rake design of the decoated grid Gmn+1.

Preferably, a majority of teeth of connected decoated grids are used for connection and even more preferably all teeth are used for the connection.

In some preferred embodiments, to facilitate the decoating steps while optimizing the time to decoat, a decoating grid has several substantially parallel edges two-by-two, preferably a rectangular or a square generic shape that even in the curved part adjacent decoated grids are easily connected edge-to-edge.

With the present invention, this over-illumination is less visible even invisible to the eye because connection points are not aligned and then the eyes see only disparate points spread over a large area and cannot see a line, composed of aligned connection points, as this is the case with the prior art.

Preferably, to optimize the time while limiting displacements, the matrix of the frequency selective surface is made by creating the decoated grids of the same row or column at once and then creating adjacent row or column and so on.

Depending on the dimension of the frequency selective surface, the dimensions of the decoated grids be adapted, ie decoated grids of the last and/or the first row and/or of the last and/or the first column has a different size than the other decoated grids to respect the dimension of the frequency selective surface to be less visible to eyes.

Coming back to FIG. 2, the decoating steps can be executed in a factory. A step 700 to provide a glazing panel with a conveyor for example. The decoating step 800 is then performed in the factory to form a partially decoated glazing unit. This method can comprises a step 900 to mount the partially decoated glazing unit on a stationary object, for instance a building, or mounted on a mobile object, for instance a vehicle, a train.

As illustrated in FIG. 3, the decoating step can be performed in situ by using an decoating apparatus that can move. The term “in situ” means that the glazing unit is already mounted on a stationary object, for instance a building, or mounted on a mobile object, for instance a vehicle, a train. The decoating apparatus is moved (701) in front of the already mounted glazing unit. The decoating step 800 is performed in situ meaning that the glazing unit stay mounted during the decoating step. Then the decoating apparatus is moved (901) to another glazing unit or to be stored.

The method permits to create a larger frequency selective surface in a fast manner, such as at least 50% of the coating system surface, preferably more than 75% of the coating system surface and even more preferably 85% of the coating system surface. In fact, the decoated grids placed in a patchwork manner and connected edge-to-edge allow to create a larger frequency selective surface especially when the decoated grids are created by a decoating apparatus using a galvo head to orientate the laser designed to decoat the coating system.

The present invention provides, in a third aspect, a decoating apparatus to decoat a glazing unit comprising a glazing panel a glass sheet which is low in reflectance for RF radiation and a coating system which is high in reflectance for RF radiation disposed on the said glass sheet by the method according to the first aspect of the present invention.

The decoating may be performed by laser ablation and the spacing of the slits, such as the decoating lines, is chosen to provide selectivity at the desired frequency. For that, the decoating apparatus comprises a laser head with a laser focused/to be focused on the coating system.

The decoating apparatus can be fixed on the glazing unit and/or around the glazing unit such as a frame surrounding the glazing unit, a car body, a wall or alike.

The decoating apparatus can stand in front of the glazing unit to decoat.

Such decoating apparatus are described in WO2015050762, WO2022112532, WO2021165064, WO2021165065, WO2021239603, WO2022079225, WO2022112530, WO2022112529, WO2022112521.

Preferably, said decoating apparatus can comprises a surface analysis means to calculate and/or estimate the radius of curvature at a specific location. Said surface analysis means can be interpreter interpreting the CAD files to calculate the radius of curvature at a specific location. Said surface analysis means can also be a camera that calculate the delta of the surface between several points to estimate the radius of curvature at this specific location.

It is understood that any other apparatus that can decoat using the method according to the second aspect and/or providing a glazing unit according to the first aspect of the present invention can be used.

The present invention, with these different aspects, permits to obtain a glazing unit comprising at least one frequency selective surface over a bent portion made of a patchwork of decoated grids less visible to eyes while optimizing the time of decoating it.

1: A decoating method for decoating a glazing unit, the glazing unit comprising:
a glass panel comprising a glass sheet which is low in reflectance for RF radiation and a bent portion with an axis of curvature Acmn; and
a coating system which is high in reflectance for RF radiation disposed on the glass sheet over at least a part of the bent portion,
the decoating method comprising:
decoating a frequency selective surface on the coating system by decoating a matrix of decoated grids, Gmn, connected together two-by-two and edge-to-edge; each of the plurality of decoated grids having decoated regions in a form of grid lines arranged in a mesh-like manner; each of the plurality of decoated grids having a rectangular generic shape with a length (Lmn) and a width (Wmn); the decoating being performed by using a laser apparatus having a scan field, Lmax, and a zone Rayleigh, Za,
wherein each of the plurality of decoated grids is inscribed in a specific rectangle Rmn having a length LRmn and a width WRmn which is paralleled to an axis of curvature Acmn; each of the plurality of decoated grids being oriented by an angle αmn to the corresponding specific rectangle;
wherein the width Wmn
$$Wmn = \frac{WRmn * cos α mn - LRmn * sin α mn}{( {cos}^{2} α mn - {sin}^{2} α mn )}$$
wherein the length Lmn
$$Lmn = \frac{LRmn - Wmn * sin α mn}{cos α mn}$$
wherein:
WRmn is from 50% up to 100% of the minimum between Lmax and Wr wherein Wr=2*sqrt(2*Za*Rmn−Za²);
LRmn is from 50% up to 100% of Lmax;
Rmn corresponds to a radius of the glass sheet at the corresponding specific rectangle of a decoated grid Gmn measured in an axis of the length; and
αmn≠kπ/2 wherein k is an odd number.

2: The decoating method according to claim 1, where WRmn is from 80% up to 100% of a minimum between Lmax and Wr wherein Wr=2*sqrt(2*Za*Rmn−Za²).

3: The decoating method according to claim 1 wherein LRmn is from 80% up to 100% of Lmax.

4: The decoating method according to claim 1, wherein each of the αmn are equals to the same angle α11.

5: The decoating method according to claim 4, where α11 is substantially equal to 0.

6: The decoating method according to claim 1, wherein the laser apparatus comprises a F-theta lens.

7: The decoating method according to claim 1, wherein the laser apparatus comprises a galvo head designed to orientate the laser beam.

8: The decoating method according to claim 1, wherein some of the plurality of the decoated grids comprise a rake design at an edge.

9: The decoating method according to claim 8, wherein each of the plurality of the decoated grid comprises a rake design on at least one edge.

10: The decoating method according to claim 9, wherein each of the plurality of the decoated grids comprises a rake design at every edge.

11: The decoating method according to claim 1, wherein the decoating step is performed in a factory.

12: The decoating method according to claim 1, wherein the decoating is performed in situ.

13: The decoating method according to claim 1, wherein the glass sheet further comprising a flat portion.

14: A partially decoated glazing unit produced by the decoating method according to claim 1.

15: A decoating apparatus to partially decoat a glazing unit using the method according to claim 1.

16: The decoating method according to claim 1, wherein LRmn is from 90% up to 100% of Lmax.

17: The decoating method according to claim 2, wherein Lmn is from 90% up to 100% of a minimum between Lmax and Lr.
